(19) United States
(12) Patent Application Publication
(10) Pub. No.: US 2018/0121951 A1
(43) Pub. Date: May 3, 2018

(54) ADVERTISING DISPLAY FOR A FAUCET CONTROL SYSTEM

(71) Applicant: Kum Foong Boey, Diamond Bar, CA (US)

(72) Inventor: Kum Foong Boey, Diamond Bar, CA (US)

(21) Appl. No.: 15/212,227

(22) Filed: Jul. 16, 2016

(51) Int. Cl. G06Q 30/02; E03C 1/05

(52) U.S. Cl. CPC G06Q 30/0241; E03C 2001/0418; E03C 1/057

(57) ABSTRACT

An advertising display for use in a prior art faucet control system is disclosed. The prior art faucet control system comprises a valve apparatus, sensors or a touch panel to be activated by a user, and a controller that controls the valve apparatus. A first sensor may start water flow and a second sensor may alter the proportion of waters delivered from two water sources. The faucet control system is provided with an electronic digital display to be used for the display of advertising and/or promotions. The advertising display may be selectively operated in either automatic or interactive formats. In the automatic format, a series of screens are successively displayed on the screen in order to provide a variety of advertisements.

### FIELD OF THE INVENTION

The present invention relates to a faucet control system and, more particularly, to an advertising digital display used in association with the faucet control system.

### BACKGROUND OF THE INVENTION

Faucets used to regulate and dispense water are typically mounted to a sanitary structure such as a sink, washbasin, bathtub, or the like. Faucet systems general include dispensing components that direct the flow of the water and regulating components that control the flow rate and temperature of the water being dispensed. The dispensing components and regulating components can be separately mounted to the sanitary structure or they can be integrally mounted to the sanitary structure as a single unit.

In many settings it is desirable to have a control system that allows for convenient control of water faucets and other water delivery fixtures. Water faucet control systems, however, lack a means for displaying advertising while in use. Therefore, it is desirable from a marketing standpoint to have the ability with a water faucet control system to display advertising in households, hotels, hospitals, and many work places. Therefore, there is a need for a faucet control system and method that allows for flexibility in placement of a temperature or water flow control in order to accommodate use by a broad range of persons while at the same time displays advertisements during use.

### SUMMARY OF THE INVENTION

The present invention is directed to an advertising display configured for advertising/promotional purposes used with a prior art faucet control system. The prior art faucet control system is described in U.S. Pat. No. 7,766,026 entitled, Faucet control system and method, which issued on Jan, 8, 2008, to Kum F. Boey which is herein incorporated by reference in its entirety and who is the applicant of the present invention. The faucet control system including an advertising digital display of the present invention is particularly well suited for use in restrooms in commercial buildings such as hotels, sport stadiums, convention centers, restaurants, etc. In one preferred embodiment the advertising digital display is an electronic digital display system such as a Liquid Crystal Display (LCD) or other equivalent screen. The screen is electronically connected to a microprocessor system. Advertising stored in the microprocessor system can be displayed in on a predetermined schedule or delivered on-line from the internet.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings.

### BRIEF DESCRIPTION OF THE DRAWINGS

FIG. 1 is a block diagram of a faucet control system showing a valve apparatus, a controller, a first sensor, a second sensor, a third sensor and a display;

FIG. 2 is a block diagram of a timed faucet control system showing hot, warmer, cold colder, timer and off touch sensors, solenoid valves, a controller having a timer and in communication with the touch panel and solenoid valves, and a power supply connected to the controller;

FIG. 3 is a graphical view of the touch panel illustrating the displays and touch switches in accordance with the present invention; and

FIG. 4 is a graphical view of system including the touch panel illustrating the displays and touch switches controller and ad processor in accordance with the present invention.

### DETAILED DESCRIPTION OF THE PREFERRED EMBODIMENTS

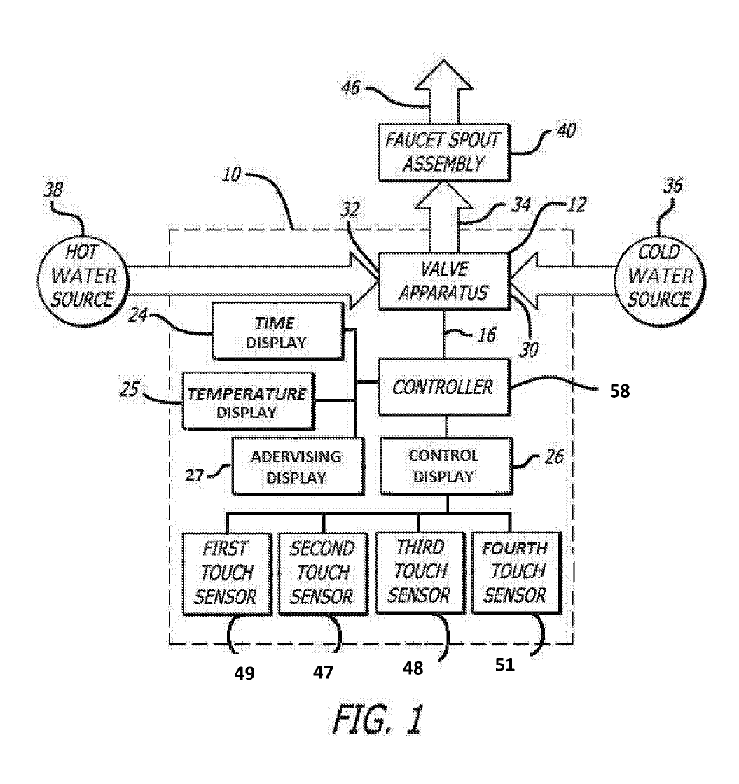

Referring now in more detail to the exemplary drawings for purposes of illustrating embodiments of the invention, wherein like reference numerals designate corresponding or like elements among the several views, there is shown in FIG. 1 a block diagram of a faucet control system 10 having a valve apparatus 12 controlled by a controller 58 that provides a valve control signal 16 to the valve apparatus. The faucet control system also has a first touch sensor 47, a second touch sensor 48, a third touch sensor 49 and a fourth touch sensor 51 that provide sensor signals to the controller 58. In use, a user presses either the first touch sensor 47 for instantaneously delivering cold water at a temperature of approximately 61 Fahrenheit degrees and may raise the temperature to a warmer temperature by pressing and holding the third touch sensor 48 and by watching the temperature display 25, release their touch when a desired warmer temperature is reached as shown on the digital temperature display 25. Similarly, by pressing the second touch sensor 49 hot water is instantaneously delivered at a temperature of approximately 110 degrees Fahrenheit, wherein if the user desires a colder temperature they press and hold the fourth touch sensor 51 and by watching the temperature display 25, release their touch when a desired colder temperature is reached as shown on the digital temperature display 25. It should be understood that the faucet control system 10 has a visual control display 26 for indicating temperature information in response to a display signal from the controller 58 and an advertising display 27 which also delivers commercial advertisements, in accordance with the present invention.

Therefore, the system comes in a four button/sensor configuration wherein each successive touch of either the third or fourth button causes a change in water temperature. In particular, each time the controller 58 receives a signal from either button/sensor 49 or 51, the controller 58 causes the valve apparatus 12 to adjust the hot/cold mixture of water. Therefore, in a four sensor configuration, one sensor 49 is a “cold” button that is pressed to deliver relatively colder water. One sensor 47 is a “hot” button that is pressed to deliver relatively hot water. The third sensor 48 is a “warmer” button that is pressed to deliver relatively warmer water after pressing for cold water. Lastly, the fourth sensor 48 is a “colder” button that is pressed to deliver relatively colder water and after pressing the hot button it may be activated multiple times to provide progressively colder water, wherein in each case the valves of the hot and cold water are controlled to allow more hot water to be added to the mix with each progressive push of the third button/sensor or colder water with progressive push of the fourth button. It should be noted that the terms “first,” “second”, “third” and “fourth” sensors may correspond to “cold,” “hot”, “cooler” and “warmer” sensors. But the terms are interchangeable, in that the “first” sensor may trigger flow of either “hot” or “cold” water, as desired by the system designer.

Turning once again to FIG. 1, the valve apparatus 12 has a cold water inlet 30, a hot water inlet 32, and a water outlet 34. A cold water source 36 and a hot water source 38 are in water communication with the cold and hot water inlets, respectively. A faucet spout assembly 40 is in water communication with the outlet 34. In the embodiment shown, the cold and hot water sources and the faucet spout assembly are separate from the faucet control system 10. Still referring to FIG. 1, the valve apparatus 12 allows a desired proportion of cold to hot water from water sources 38, 36 to be delivered to faucet spout assembly 40. As described in more detail below, the delivery of the desired proportion of cold to hot water is prescribed by a user of the faucet control system 10 by activating the first, second, third and/or fourth sensors 49, 47, 48 and 51, respectively. et

The control display 26 is visible to the user of the faucet spout assembly 40. The display 26 is configured to indicate the proportion of cold to hot water that the valve apparatus 12 is delivering to the faucet spout assembly. The display may include an alphanumeric display 25 or a plurality of lights or light emitting diodes (LEDs) that are controlled by a display signal (not shown) provided by the controller 58. For example, the display 26 may show the numeral one or illuminate one LED to indicate that only cold water is being delivered by the faucet spout assembly. The display 26 may show the numeral two or show two LEDs illuminated to indicate that the first mixture of cold and hot water is being delivered. Continuing further, the display 26 may show the numeral three or illuminate three LEDs to indicate that the second mixture of water having a higher proportion of hot water is being delivered. Finally, the display 26 may show the numeral four or illuminate four LEDs to indicate that only hot water is being delivered.

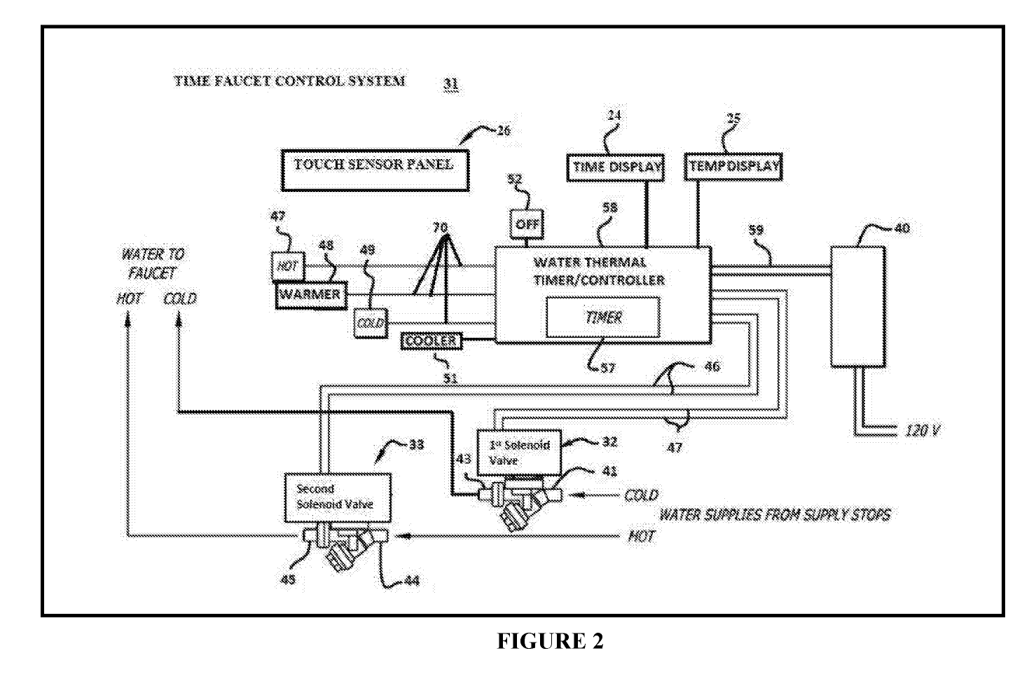

Referring now to FIGS. 2 through 4 shows a timed faucet control system 31 that comprises a touch sensor or panel 26, a first solenoid valve 32, a second solenoid valve 33, a water thermal timer/controller 58 having a timer 57, and a power supply 40. The water thermal timer/controller 58 is connected 59 to the power supply 40 and is in communication with the touch panel 26 and the first and second solenoid valves 32, 33. The power supply 40 is configured to accept 100-240 volts, 50/60 Hz power and to be plugged into a standard household power receptacle or outlet. The power supply 40 provides 12-volt DC power to the water thermal timer/controller 58, although other voltages may be provided that are suitable for operating the first and second solenoid valves 32, 33. The first solenoid valve 32 is adapted to provide cold water from a cold water source to a faucet. The first solenoid valve includes a first valve inlet 41 and a first valve outlet 43. The first valve inlet 41 is configured to be connected to the cold water source and may include standard threads or fittings that mate with household or commercial plumbing lines. The first valve outlet 43 is configured to be connected to a cold water outlet of the faucet. A pair of first valve electrical leads 47 connects the first solenoid valve 32 to the water thermal timer/controller 58.

Turning once again to FIGS. 2 through 4, the second solenoid valve 33 is adapted to provide hot water from a hot water source to the faucet. The second solenoid valve includes a second valve inlet 44 and a second valve outlet 45. The second valve inlet 44 is configured to be connected to the hot water source and may include standard threads or fittings that mate with household or commercial plumbing lines. The second valve outlet 45 is configured to be connected to a hot water outlet of the faucet. A pair of second valve electrical leads 46 connects the second solenoid valve 33 to the water thermal timer/controller 58.

Turning yet once again to FIGS. 2 through 4, the touch panel 26 includes six touchscreen switches 52: a hot switch 47, a warmer switch 48, a cold switch 49, a cooler switch 51, a timer switch 57, and an off switch 53. Each touchscreen switches 47, 48, 49, 51, 57 and 53, respectively, may be selectively activated and deactivated using the touchscreen 26 which is connected to and controlled by the water thermal timer/controller 58 by separate pairs of touch panel electrical leads 70. The switches 47, 48, 49, 51, 57 and 53, respectively, may be configured as mat switches. Preferably, each mat switch 47, 48, 49, 51, 57 and 53 functions as a momentary-contact, normally-open, single-pole, single-throw switch. Each mat switch 47, 48, 49, 51, 57 and 53 preferably includes at least one pair of flexible conductive sheets. The flexible conductive sheets in each mat switch 47, 48, 49, 51, 57 and 53 are configured to be spaced apart in a normally-open configuration when no pressure is applied to an exposed outer surface adjacent to one of the flexible conductive sheets. The flexible conductive sheets in each mat switch 47, 48, 49, 51, 57 and 53 are also configured to make contact with each other when pressure is applied to the exposed outer surface of the touch panel 50. Preferably, the portions of the exposed outer surface corresponding to the hot switch 47, the warmer switch 48, the cold switch 49, the cooler switch 51, the timer switch 57, and the off switch 53 are labeled to indicate hot, warmer, cold and colder to allow a user to select the desired water temperature and a chosen time or to turn the timed faucet control system 31 off.

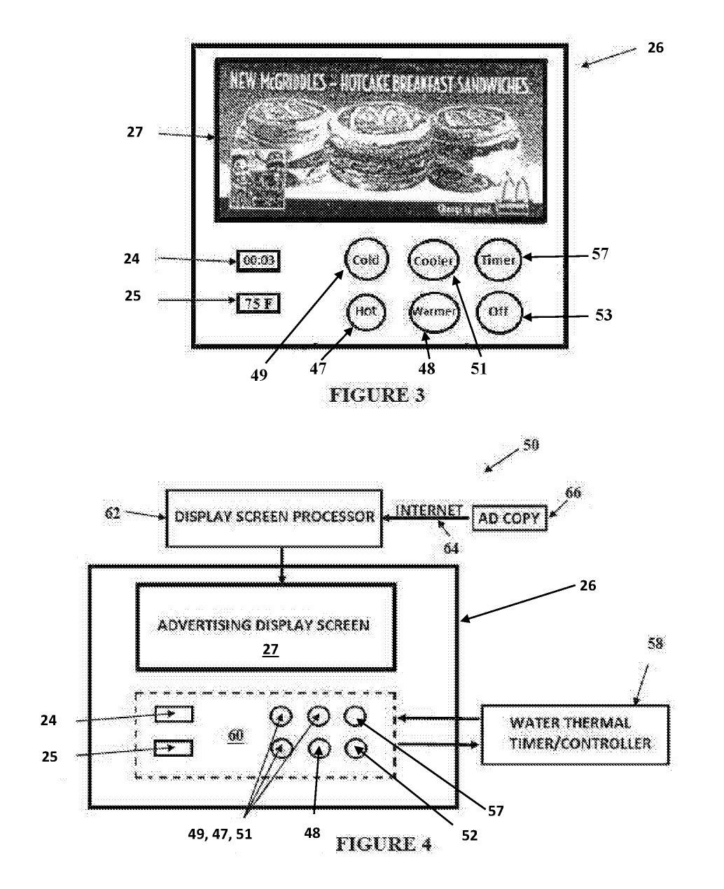

Turning now to FIGS. 3 and 4, the touch panel 26, includes three displays, a timer display 24, a temperature display 25 and a digital advertising display 27. As shown in the Figures, the timer 24 and temperature 25 display are connected to and controlled by the water thermal timer/controller 58 and are grouped together and located in an area 60 located under the digital advertising display 27. It should be understood that the timer and temperature display 24, 25 are grouped with the touchscreen switches 47, 48, 49, 51, respectively in an area 60 wherein the digital advertising display 27 is larger and located in the top portion of touch panel 26 with the switches 47, 48, 49, 51, respectively and displays 24 and 25 located underneath on touch screen 26. In accordance with the present invention, the digital advertising display 27 receives ad copy from a display screen processor 62 streamed in from the internet 64 or may be preprogramed advertisements stored in processor 62.

The water thermal timer/controller 58 is also configured to continue providing electrical power to one or both of the valves 32, 33 after pressure is removed from the touch panel 26 such that the desired water temperature continues to be delivered to the faucet. In this way, water continues to be delivered to the faucet after the switches 47, 48, 49, 51 have been deactivated. It will be appreciated that a user of the timed faucet control system 31 need not apply pressure continuously to the touch panel 26 in order to have water at a desired temperature flow out of the faucet continuously. The water thermal timer/controller 58 is further configured by means of the timer 57 to automatically discontinue providing one or both of the valves 32, 33 with electrical power after a selected amount of time has passed after the switches 47, 48, 49, 51 have been deactivated with removal of pressure from the touch panel 26. In this way, water automatically ceases to flow out of the faucet after the selected period of time. The period of time may be selected by a user as desired by pressing on the timer switch 57. It will be appreciated that a user of the timed faucet control system 31 need not touch the faucet or any portion of the system 31 after the user washes his or her hands in order to maintain cleanliness and at the same time may view digital advertising streaming across digital display screen 27.

While several particular forms of the invention have been illustrated and described, it will also be apparent that various modifications can be made without departing from the scope of the invention. It is also contemplated that various combinations or subcombinations of the specific features and aspects of the disclosed embodiments can be combined with or substituted for one another in order to form varying modes of the invention. Accordingly, it is not intended that the invention be limited, except as by the appended claims.

What is claimed is:

1. An advertising display for use in a faucet control system comprising:
a valve apparatus, sensors or a touch panel to be activated by a user, and a controller that controls said valve apparatus and an advertising digital display for streaming digital advertising.

2. The advertising display for use in a faucet control system according to claim 1, wherein said streaming digital advertising is from the internet and processed through a digital screen processor for display on said advertising digital display.

3. The advertising display for use in a faucet control system according to claim 1, wherein said streaming digital advertising is from a digital screen processor within said touch panel for display on said advertising digital display.

4. The advertising display for use in a faucet control system according to claim 1, wherein said sensors are a first sensor to start water flow and a second sensor to alter proportion of waters delivered from two water sources and timer switch for use with a timer display.

5. The advertising display for use in a faucet control system according to claim 1, wherein said advertising display is an electronic display used for the display of advertising and/or promotions and is operated in an automatic format.

6. The advertising display for use in a faucet control system according to claim 3, wherein said automatic format is a series of screens successively displayed on said screen in order to provide a variety of advertisements.

7. The advertising display for use in a faucet control system according to claim 1, wherein said advertising display is an electronic display used for the display of advertising and/or promotions and is operated in an interactive format.

8. The advertising display for use in a faucet control system according to claim 5, wherein said automatic format is a series of screens successively displayed on said screen in order to provide a variety of advertisements.
